(19) United States
(12) Patent Application Publication
(10) Pub. No.: US 2003/0212629 A1
(43) Pub. Date: Nov. 13, 2003

(54) Authent-eCard is an implementation of business rules and a rules engine on a portable data device, point-of-sale interface and internet portal to apply predefined rules to the automated approval of financial transactions

(76) Inventor: Philip Joseph Benton King, Murfreesboro, TN (US)

Correspondence Address: Philip J. King, 3007 Madison Ave., Murfreesboro, TN, 37130, US

(21) Appl. No.: 10/140,781

(22) Filed: May 7, 2002

(51) Int. Cl. G06F 17/60

(52) U.S. Cl. 705/39

(57) ABSTRACT

Authent-eCard employs business rules, a business rule engine on a portable data device and an Internet portal to allow for automated, predefined controls on financial transactions. These business rules are the codification of policies and procedures for which the card-holder may obtain goods and services. By combining the portable data device, merchant or service provider interface, and portal, the rules may be dynamically applied and employ complex historical data logic for frequency and asset associated data. This pre-purchase verification and authorization of purchases replaces post-purchase audits, systems, and expense analysis as financial spending controls.

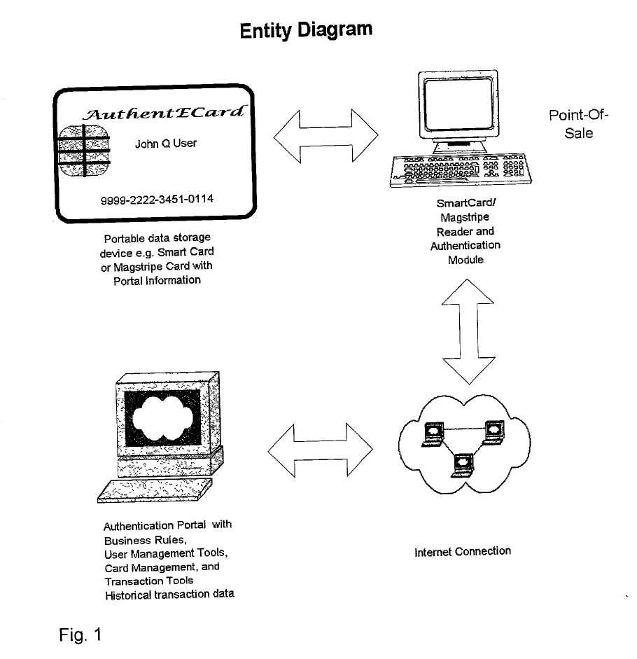

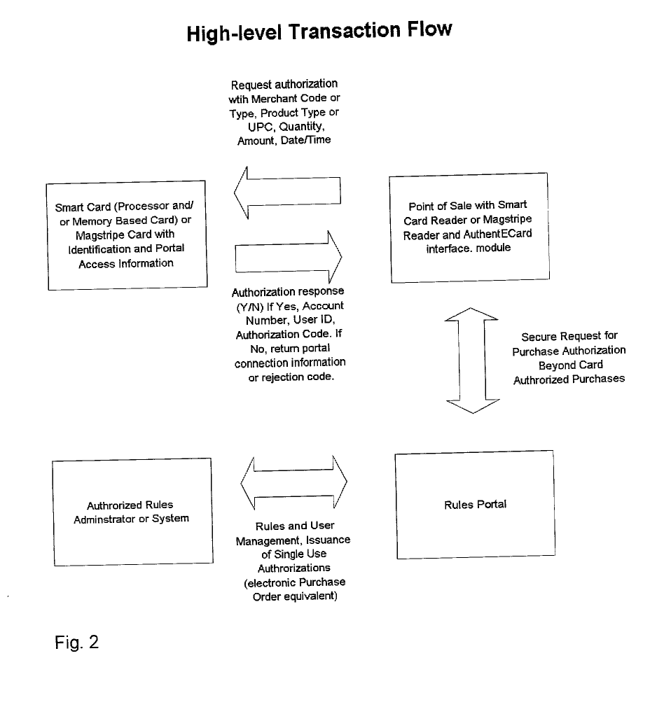

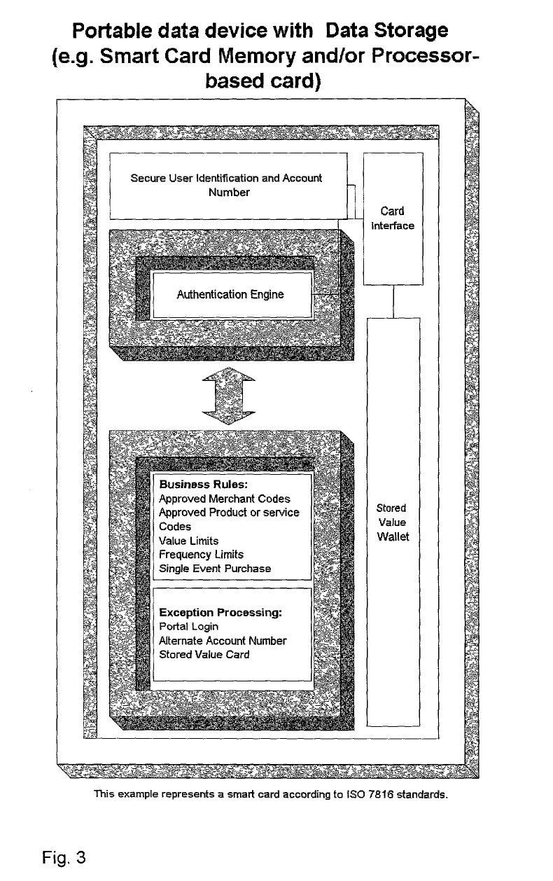

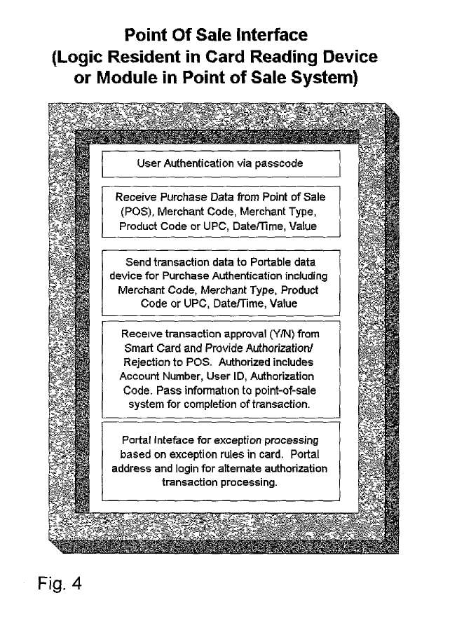

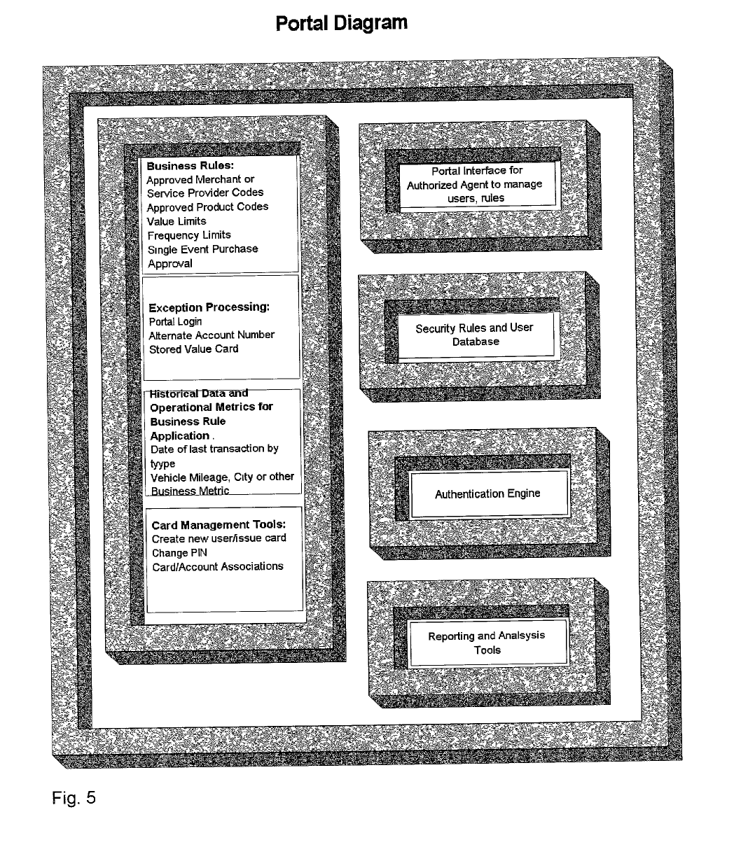

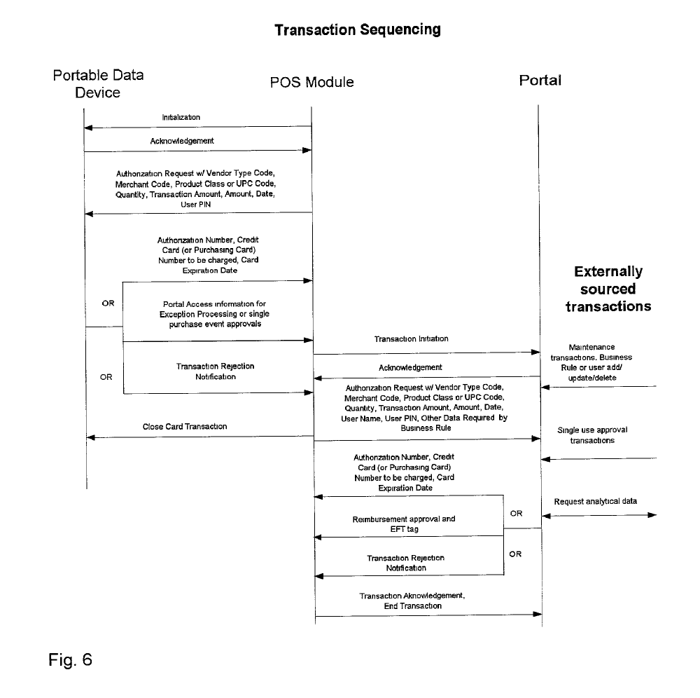

### SUMMARY OF INVENTION

This business process, logic, and technology platform employed, provides for financial transactions to be constrained to pre-defined rules stored on the portable-data device or the portal. These may be accessed by a point-of-sale system or claims processing terminal. This allows card issuers to employ pre-purchase authorization of a credit purchase, reimbursement claim or other financial transaction against predefined rules replacing the need for post purchase auditing and approval processes. These business rules represent the authorization policies and procedures applied to the card-holder.

### BRIEF DESCRIPTION OF DRAWINGS

The following diagrams provide a high-level overview of the system, and a description of the major subsystems.

Entity diagram: The entity diagram shows the three major subsystems of this invention. These include: 1) The logic and/or data stored on a portable-data-storage device (e.g. smart card, or magstripe card); 2) an interface module for a point-of-sale system or reimbursement-system terminal; and the Internet Portal to provide real-time exception processing, support for complex rules, historical transaction recording, and single-event approvals for the card holder.

High Level Transaction Flow: This diagram provides information regarding the interaction of these subsystems with one another. The fully integrated process flow provides almost limitless options for coding discrete business rules and verification for financial transactions. This platform provides for flexible implementation by the specific issuer based on specific business models. For example, very static, simple rules may be encoded on a data only device such as a magnetic striped card. More complex rules with security or rules that are dynamic and require updates may be implemented using a smart card and encryption keys. The portal provides ultimate extensibility for complex rules and extension of the card's functionality.

Portable Data Device: This diagram represents one implementation of the portable-data-device. This includes the business rules stored on a dynamic environment that may be updated along with an on-board rules engine. This implementation may occur on a smart card that conforms to the ISO 7816 standards.

Future smart technology devices may also provide the platform for this functional capability. In the most-simple form, this data device may be a magnetic card such as one compliant with EMVCo specifications.

The business rules repository and rules engine may reside on the card and/or on the portal depending on the implementation selected, the complexity of the rules, the static or dynamic nature of the rules.

The rules repository is a codification of specific criteria that represent an approved financial transaction. These rules may include specific vendors, vendor types, product or service types, specific UPC codes, transaction dollar values, transaction frequencies by type by user, unique asset identifiers associated with the purchase, historical transaction data, or other discrete data associated with the transaction. For reimbursement implementations, the rules database may include a codification of reimbursement rules, frequency, exception processing or escalation, or historical data.

The rules engine is a computer program that accepts data from the requesting unit about the transaction. The engine then compares this data to the rules repository to approve, reject or escalate the transaction. Based on the results from the rules database, the engine will return appropriate transaction detail to the requesting device, information to authorize the transaction, reject the transaction or access the rules portal for escalation of the request.

Point-of-Sale Interface: Whether deployed as a software module for the merchant's point of sale system or embedded in a card reader accessory to the point of sale system, this application provides the communication interface between the point of sale system, the smart card or portable user device, and the portal. This integrates the transaction process across the merchant, card holder, and issuer platforms to authorize the transaction between that user and that merchant based on the rules defined by the card issuer.

Portal Diagram: The portal contains several sub-modules.

The business rules repository and rules engine may reside on the portal depending on the implementation selected, the complexity of the rules, the static or dynamic nature of the rules.

The rules repository is a codification of specific criteria that represent an approved financial transaction. These rules may include specific vendors, vendor types, product or service types, specific UPC codes, transaction dollar values, transaction frequencies by type by user, unique asset identifiers associated with the purchase, historical transaction data, or other discrete data associated with the transaction. For reimbursement implementations, the rules database may include a codification of reimbursement rules, frequency, exception processing or escalation, or historical data.

The rules engine is a computer program that accepts data from the requesting unit about the transaction. The engine then compares this data to the rules repository to approve, reject or escalate the transaction. Based on the results from the rules database, the engine will return appropriate transaction detail to the requesting device information to authorize the transaction, reject the transaction or access the rules portal for escalation of the request.

The user profile repository maintains contact, security and issuer association about authorized users. This also includes the specific rules to authorize transactions for the user, historical data of user transactions, prompts to request additional information regarding the transactions.

The analysis and reporting tools on the portal allow card issuers to perform analysis and reporting on user activity.

The transaction processor/messaging queue allows card issuers to initiate single use “rules” or approvals that will be associated with a card holder merchant and product or service.

Transaction Sequencing: The smart card component highlights the system components residing on the smart cardThe point of sale module description describes the components and function of the module associated with the merchant's point-of-sale system.

The portal description describes the functional components of the portal for managing business rules, exceptions, historical transaction data, and user profiles. The transaction sequence diagram provides an example sequence of transactions to complete a pre-authorized purchase.

### DETAILED DESCRIPTION

Business rules stored on the card or portal represent a codification of business policies under which the cardholder is authorized to execute financial transactions. These rules may consider factors such as: specific selling merchant or service provider, merchant or service provider type, product, commodity, or service type or specific UPC code, dollar value of the transaction, frequency of this type of transaction or dollar value, associated equipment serial or id number, other business rule required data such as vehicle mileage Smart Card or Portable User Data Storage Device Application and Process: Through the use of a smart card or other portable, secure data storage tool, business rules may be stored on the device allowing the point of sale system to provide specific data to be validated against the rules stored on the device. Based on the information and the rules for authorized transactions, the card will return a code to authorize the transaction, reject the transaction or refer the point of sale system to the portal via an Internet connection to allow the exception to be validated against a more robust set of business rules. At a minimum a card may be used which stores only user information and portal access instructions to defer all validation to the portal.

Point-of-Sale Module: Whether deployed as a software module for the merchant's point of sale system or embedded in a card reader accessory to the point of sale system, this application provides the communication interface between the point of sale system, the smart card or portable user device, and the portal. This integrates the transaction process across the merchant, card holder, and issuer platforms to authorize the transaction between that user and that merchant based on the rules defined by the card issuer.

Portal: The portal serves many functions. The primary function of the portal is to provide dynamic, real time and complex business rule capabilities to the authentication process. This allows single use business rules to be established by the card issuer much like a purchase order for specific products and services from a specific vendor. More complex business rule applications may be applied to the frequency of a transaction type such as meal limitations, fuel purchase limits, vehicle miles between transactions, days or hours between transactions, or historical services (e.g. medical) for reimbursement calculations. These complex rules require the historical data to validate frequency rules and to provide prompts to the merchant for data required as part of this transaction.

Secondary functions of the portal are required to support the primary rules based function. These include the ability to create and maintain cardholder profiles, create and maintain business rules by cardholder, interfaces to support specific transactions from external systems such as a purchase order system, transaction analysis and reporting, and security features to reduce fraud and error.

What is claimed includes:

1. I claim that this invention provides a new and unique process to electronically validate business transactions pre-purchase instead of post purchase through the use of defined business rules that constrain the financial transaction based on the discrete attributes or characteristics of that transaction.

2. I claim that this invention provides a new and unique process to perform reimbursement transactions such as medical reimbursement authorization and initiation of the reimbursement process through the use of defined business rules that constrain the financial transaction based on the discrete attributes or characteristics of that transaction.

3. I claim that the unique and specific use of an Internet Portal for this application for the storage of business rules and transaction history provides for a more complex set of rules based on historical frequencies of transaction types and association with specific assets being modified or maintained.

4. I claim that this unique and specific application of portable data storage devices such as magnetic stripe cards and smart cards increases the security of financial transactions and dramatically increases the financial controls of the card-holder and issuer over the user of the card in purchasing or reimbursement transactions without other commercial transaction documents such as a purchase order.

5. I claim that the unique and specific use of an interface between the merchant's point-of-sale system and the portable data storage device and the internet portal provides a new and innovative financial control process to insure the cardholder is authorized to make the proposed purchased before the transaction is completed.
